(19) United States
(12) Patent Application Publication
(10) Pub. No.: US 2025/0020183 A1
(43) Pub. Date: Jan. 16, 2025

(54) Bulk Metallic Glass (BMG) Springs For Downhole Applications

(71) Applicant: Halliburton Energy Services, Inc., Houston, TX (US)

(72) Inventors: Shashwat Shukla, Singapore (SG); Arpana Singh, Singapore (SG)

(73) Assignee: Halliburton Energy Services, Inc., Houston, TX (US)

(21) Appl. No.: 18/745,630

(22) Filed: Jun. 17, 2024

Related U.S. Application Data
(60) Provisional application No. 63/526,129, filed on Jul. 11, 2023.

(51) Int. Cl. F16F 1/02; E21B 23/00

(52) U.S. Cl. CPC F16F 1/021; E21B 23/00; F16F 2224/0208

(57) ABSTRACT

A variety of methods and apparatuses are disclosed, including, a downhole tool for a wellbore, the downhole tool having a spring comprising bulk metallic glass (BMG), and a method of positioning the downhole tool having the spring comprising BMG in the wellbore.

### CROSS REFERENCE TO RELATED APPLICATIONS

This application claims the priority of U.S. Provisional Patent Application No. 63/526,129, filed July 11. 2023, which is incorporated by reference in its entirety.

### BACKGROUND

Boreholes may be drilled into subterranean formations to recover valuable hydrocarbons, among other functions. Operations may be performed before, during, and after the borehole has been formed to produce (flow) hydrocarbon fluids from the subterranean formation through the borehole to the surface. A borehole may be labeled as a wellbore.

Typical operations concerning downhole applications may be to employ downhole tools and equipment in the wellbore. There may be a variety of different downhole tools (and equipment) that have a spring. Compression coils (i.e., springs) are commonly used in a variety of industries and often require a specific combination of desirable mechanical and chemical properties. For example, springs may be rated by any of their tensile strength, elasticity, spring constant, yield strength, susceptibility to corrosion, and the like. These mechanical and chemical properties may be used to determine the suitability of a spring for a particular industrial application.

### BRIEF DESCRIPTION OF THE DRAWINGS

These drawings illustrate certain aspects of some of the examples of the present disclosure and should not be used to limit or define the method.

FIG. 1 is a diagram of a downhole tool having a spring in a downhole environment, and in which the spring includes bulk metallic glass (BMG).

FIG. 2 is a diagram depicting the difference between a crystalline structure and an amorphous structure.

FIG. 3 is a plot showing Young's Modulus of various materials as a function of strength.

FIG. 4 is a plot showing fracture strength of various materials as a function of Young's modulus.

FIG. 5 is a plot showing the glass transition temperature of various compounds including two cobalt-based BMGs.

FIG. 6 is a top-down close-up view of an Mg-based BMG exhibiting super plasticity.

FIG. 7 is a diagram of a well site employing a downhole tool having a spring that includes BMG.

FIG. 8 is a diagram of a packer element having a garter spring that includes BMG.

FIG. 9 is a cross sectional view of a downhole well tool having a spring that includes BMG.

FIG. 10 is a cross sectional view of a sliding mandrel and a BMG spring.

FIG. 11 is a diagram of a torsion spring for a downhole tool including a tubing-retrievable safety valve.

FIG. 12A is a portion of a downhole tool having a BMG torsion spring installed over a flow tube.

FIG. 12B is a diagram of the BMG torsion spring of the downhole tool portion depicted of FIG. 12A.

FIG. 13A is a side cross section of a portion of a downhole tool having a push spring.

FIG. 13B is an end cross section of the portion of the downhole tool of FIG. 13A.

FIG. 13C is a diagram of the push spring of the downhole tool portion of FIG. 13A and FIG. 13B.

FIG. 14A is a side cross section of a portion of a downhole tool having a garter spring.

FIG. 14B is a diagram of the garter spring of FIG. 14A.

FIG. 15 is a diagram of a well site employing a downhole tool having a spring that includes BMG.

### DETAILED DESCRIPTION

Some aspects of the present disclosure are directed to downhole tools for a wellbore and in which the downhole tools have a spring that includes bulk metallic glass (BMG). Downhole tools are tools for downhole in a wellbore and/or subterranean formation in the Earth crust. A downhole tool may be labeled as a well tool or downhole well tool. A spring that includes BMG may be a spring in which all or a portion of the spring is BMG. Such a spring may be labeled as a BMG spring. The BMG are solid non-crystalline metallic alloys having strength, hardness, and elasticity.

The downhole tools (well tools or wellbore components) having the springs (having the BMG) may be, for example, mechanical packers, annular packers (e.g., retrievable packers), cavern packers, casing patches, tubing-retrievable safety valves, casing repair tools, gas lift mandrels, tubing plugs, casing pressure testing tools, downhole shut-off tools, centralizers, casing scrapers, liner hangers, hydraulic tools, setting tools, safety valves, bridge plugs, frac plugs, cement retainers, tubing anchors, fishing tools, swab cups, jet perforation tools, circulation tools, gas lift valves, safety joints, and so on. The springs (having BMG) of the present disclosure for downhole tools may be, for example, a compression spring, a coil spring, a torsion spring, an extension spring, a leaf spring, a constant force spring, a garter spring, a flapper spring, a push spring, and the like. The springs may be utilized as a component of downhole tools in various environments including, for example, land and/or subsea downhole environments such as in storage operations (e.g., CO₂ storage, H₂ storage, etc.), wellbore and borehole operations (e.g., drilling and drill-in operations, production, stimulation, fracturing, etc.), wireline operations, high-temperature high-pressure (HTHP) operations, and the like, as well as non-downhole environments.

Embodiments include the BMG (of the spring of the downhole tool) having cobalt as the major element in that the BMG has at least 40 atomic percent (at %) of cobalt. Therefore, in these embodiments, the BMG is a Co-based BMG. Implementations herein of BMG for springs include BMG having an amorphous structure with no nanocrystalline phases.

As indicated, downhole applications include conventional wells, underground storage operations (e.g., carbon capture, hydrogen storage, etc.), and other downhole configurations and operations. The mechanical and chemical properties of springs beneficial for downhole tools may become stricter. A challenge may be to significantly increase the yield strength of the spring material, while still maintaining the elastic modulus of the material.

Springs may benefit from various sets of properties to satisfy functional workings. In comparison to conventional springs, a spring being BMG may increase the spring constant (e.g., via increased elastic modulus) to facilitate that the spring offers an adequate reaction force in response to a given deflection. A spring being a BMG may increase peak force via increased elastic modulus along with adequate yield strength. Peak force is the maximum force that the spring can exert before undergoing permanent deformation.

A spring as a BMG spring compared to conventional springs can increase (via increased clastic resilience) the stroke length of the spring. Stroke length refers to the amount of compression the spring can be put under without yielding. Increased elastic resilience (ratio of yield strength to elastic modulus) can increase deflection of the spring material.

A spring as a BMG spring in comparison to conventional springs can increase energy absorption capability, e.g., promoted by increased modulus of elastic resilience. High elastic resilience can increase deflection and yield strength to accommodate more allowable stress. Deflection and yield strength, together, as the modulus of elastic resilience is significant for amount of energy the spring can absorb before failure.

The performance of downhole tools and their springs can be improved with the spring as a BMG spring in conventional wells (e.g., oil and/or gas wells, etc.). The performance envelope of downhole tools with their spring as a BMG spring can be expanded to new and more challenging storage wells.

BMGs, also known as metallic glass, amorphous metal, amorphous alloy, or glassy metal, arc metal alloys having a disordered atomic-scale structure (glass-like) that is amorphous (non-crystalline) and exhibits electrical conductivity and metallic luster. BMG can be produced, for example, by rapid cooling, physical vapor deposition, solid-state reaction, ion irradiation, and mechanical alloying. BMG may be considered true glasses in that BMG softens and flows upon heating, facilitating processing, such as by injection molding, similar to thermoplastic polymers. BMGs are tougher and less brittle than oxide glasses and ceramics.

BMGs can be a metal alloy, for example, of three or more of the following: zirconium (Zr), copper (Cu), silver (Ag), aluminum (Al), titanium (Ti), nickel (Ni), niobium (Nb), chromium (Cr), tantalum (Ta), beryllium (Be), magnesium (Mg), lanthanum (Ln) (or lanthanides), palladium (Pd), calcium (Ca), platinum (Pt), gold (Au), iron (Fe), cobalt (Co), yttrium (Y), hafnium (Hf), molybdenum (Mo), erbium (Er), gallium (Ga), tin (Sn), and tungsten (W). BMGs may also include metalloids or non-metallic components, such as boron (B), carbon (C), phosphorous (P), or silicon (Si), or any combinations thereof.

For a metal present in the BMG (alloy) at least 40 atomic percent (at %), the BMG may be labeled as based on that metal. For instance, a BMG having Mg at least 40 at % can be called an Mg-based BMG. Likewise, a BMG having Co at least 40 at % can be called a Co-based BMG.

In implementations herein, the BMG of the spring (the BMG utilized to form the spring) is a Co-based BMG. Thus, the major element (greater than 40 at %) in the BMG is Co. In addition to the major element being Co in these implementations, the BMG has at least two minor elements in the alloy that can include Fe, Cr, Mo, Er, Ta, Nb, Ni, or Cu. This Co-based BMG can include non-metallic (or metalloid) components, for example, B, C, P, or Si, or any combinations thereof. In examples, these Co-based BMG are an amorphous structure without nanocrystalline phases. The absence of nanocrystals can be confirmed by transmission electron microscopy (TEM). Implementations of this Co-based BMG have a glass transition temperature of at least 450° C., such as in the ranges of 450° C. to 500° C., 450° C. to 525° C., 450° C. to 550° C., 450° C. to 570° C., 450° C. to 575° C., 450° C. to 600° C., 450° C. to 600° C., 450° C. to 700° C., or 450° C. to 800° C. Implementations of these Co-based BMG may have high glass formability manifested by a casting diameter (e.g., critical casting diameter) of at least 2 millimeters (mm), e.g., in the range of 2 mm to 6 mm. This high glass formability facilitates the BMG to maintain amorphous structure up to a spring wire diameter of at least 2 mm, e.g., in the range of 2 mm to 6 mm, without forming any nanocrystalline phases. Again, the absence of nanocrystalline phases can be confirmed by TEM.

In accordance with implementations herein, the composition and amorphous structure of the BMG for the spring of the downhole tool is designed such that the BMG has a high clastic modulus, such as at least 200 gigapascal (GPa), e.g., in the range of 200 GPa to 400 GPa. This may provide for spring to have a large spring constant. The composition and amorphous structure of the BMG may be designed such that the BMG has a high strength, such as at least 5000 megapascals (MPa), e.g., in the range of 5000 MPa to 8000 MPa, facilitating for the spring to have an enhanced load-bearing capability without undergoing permanent deformation. This combination of high clastic modulus (at least 200 GPa) and high strength (at least 5000 MPa) promotes the spring to have a large stroke length and an enhanced capability to store and release elastic strain energy. The BMG of the spring for the downhole tool has strong corrosion resistance to sodium chloride (NaCl), sulfuric acid (H₂SO₄), and hydrochloric acid (HCl), and without undergoing pitting in chloride containing solutions.

In implementations, the composition and amorphous structure of the BMG for the spring is designed such that the BMG has a superplastic elongation of at least 400%, e.g., in the range of 400% to 650%. This may provide for superplastic flow that imparts thermoplastic processability to the BMG and facilitate the production of BMG springs by thermoplastic forming or similar techniques. BMG has a high clastic modulus superior to conventional state-of-the-art alloys utilized for springs, such as MP35N® and Elgiloy® alloy. In examples, BMG has a yield strength that exceeds the yield strength of MP35N by a factor of at least four and the yield strength of Elgiloy by a factor of at least two. Additionally, BMG is generally chemically inert and can operate over a wider temperature range than conventional state-of-the-art spring materials such as MP35N and Elgiloy. MP35N is a nickel-cobalt alloy with high strength, toughness, and corrosion resistance. The MP35N nominal chemical composition by weight is 35% cobalt, 35% nickel, 20% chromium, and 10% molybdenum. Elgiloy is a Co—Cr—Ni alloy that can be labeled as a super- alloy. Elgiloy nominal composition by weight is 39-41% cobalt, 19-21% chromium, 14-16% nickel, 11.3-20.5% iron, 6-8% molybdenum, 1.5-2.5% manganese and 0.15% maximum carbon. Elgiloy generally meets Aerospace Material Specification (AMS) 5876 and AMS 5833. AMS specifications are established by the Society of Automotive Engineers (SAE).

In implementations, the energy absorption capability of BMG springs is at least 5 times (e.g., 5 to 10 times) greater than with springs made of Elgiloy or MP35N. BMG springs can clastically absorb relatively large amounts of energy. Therefore, in implementations of the BMG springs, there is little or no plastic strains and thus little or no fatigue in operation. In contrast, plastic deformation of conventional springs is difficult to avoid and thus conventional springs may be shot-peened to safeguard against any potential fatigue occurring during service. In implementations, the working temperature of BMG are, for example, 250° C. to 300° C. greater than the working temperature of Elgiloy or MP35N springs. When a low working temperature is desired, e.g., in carbon, carbon capture, utilization, and storage (CCUS) applications, BMG with applicable or alternative compositions can be utilized.

As discussed, disclosed herein are methods and apparatuses involving BMG and, more particularly, disclosed are BMG springs (e.g., configured for downhole tools) and methods of use and manufacture thereof. Advantages of the methods and apparatuses of the present disclosure may include, for example, improved performance envelopes for springs as BMG springs in downhole tools compared to conventional springs. Specifically, incorporation of a BMG within the springs of the present disclosure can result in improved functional performance of the spring despite the challenging environments within which the springs may be used. These functional performance characteristics refer to, for example, high Young's modulus, high yield strength, operability over a wider range of temperatures, reduced or minimal chemical reactivity (e.g., inert), improved or increased corrosion resistance (e.g., to water, CO₂, acid), increased energy absorption capability, high spring constant, high peak force, long stroke length, high glass transition temperature, and high superplastic elongation. Other advantages may relate to improved (increased) case of manufacture of the spring, for example, thermoplastic processability. In addition, use of BMGs within springs may reduce or minimize waste, conserve raw materials, and lower production time and costs due to its case of manufacture, and may allow for the production of complex or irregular geometries with less time and cost than what would be achievable using conventional machining or casting methods.

As discussed, the springs of the present disclosure generally include one or more BMGs. BMGs, also known as amorphous metals, exhibit non-crystalline, amorphous atomic structure similar to glass. The absence of crystallinity results in useful properties, as mentioned. For example, BMGs may exhibit good corrosion resistance, low friction, and high elasticity. Moreover, BMGs may be molded and shaped due to their ability to flow at temperatures above their glass transition temperature. This facilitates the BMGs to be used in non-traditional manufacturing methods such as near-net-shape manufacturing.

Optionally, nanocrystals may be included in the BMG during and/or after manufacture. For example, a BMG of the present disclosure may have included therein up to 10% nanocrystals. Where used, nanocrystals may be used to tailor the specific properties of the springs as desired. In other examples, the BMG may be free or essentially free of any crystalline structures.

The springs of the present disclosure may be manufactured using, for example, fused disposition modeling, laser sintering, laser selective melting, electron beam melting, directed energy deposition. In other examples, the springs of the present disclosure may be manufactured utilizing rapid solidification techniques such as injection molding, blow molding, die casting, groove quenching, and thermoplastic forming methods, to use non-limiting examples. In addition, the springs of the present disclosure may be treated by techniques such as laser shock peening and/or deep cold rolling. Laser shock peening and deep cold rolling may improve the springs' resistance to fatigue.

Various properties of the springs of the present disclosure are described herein. It should be understood that the various properties disclosed are exemplary in nature and should not be used to limit or define the invention. Particularly, the exact measurable properties of a BMG spring may vary depending on its exact composition.

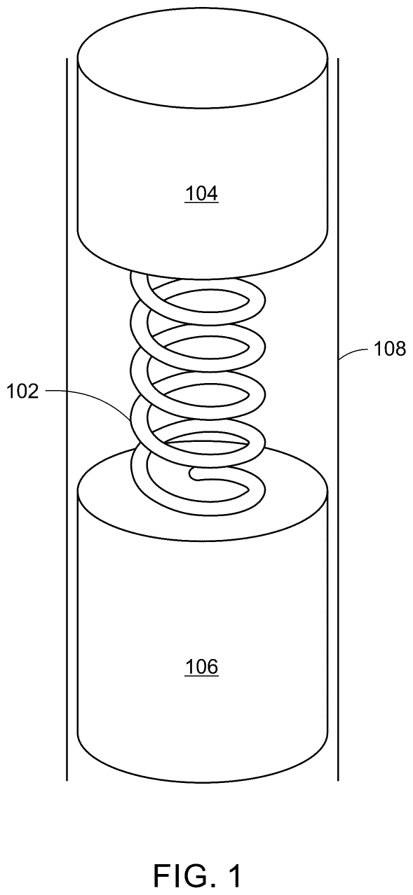

FIG. 1 is a simplified representation of a downhole tool having a spring 102, an annular clement 104, and an annular element 106. The spring 102 is situated between the annular element 104 and the annular element 106. The downhole tool is disposed within a wellbore 108 in a subterranean formation. Thus, the spring 102 is disposed in a downhole environment. In the illustrated embodiment, the spring 102 includes BMG. The spring 102 is depicted as axial but can be radial or other alignment. The annular elements 104, 106 can be a geometry other than annular.

As mentioned, the downhole tool (well tool or wellbore component) may include, for example, a mechanical packer, annular packer (e.g., retrievable packer), cavern packer, casing patch, tubing-retrievable safety valve, casing repair tool, gas lift mandrel, tubing plug, casing pressure testing tool, downhole shut-off tool, centralizer, casing scraper, liner hanger, hydraulic tool, setting tool, safety valve, bridge plug, frac plug, inflow control device (ICD), cement retainer, tubing anchor, fishing tool, swab cup, jet perforation tool, circulation tool, gas lift valve, safety joint, etc.

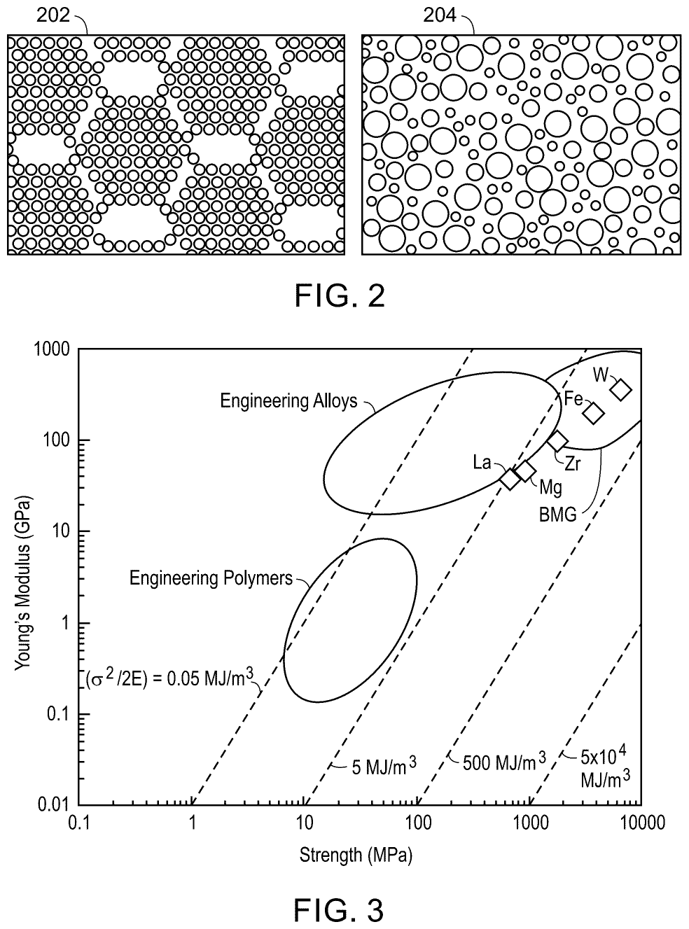

FIG. 2 is a diagram depicting the difference between a crystalline structure 202 (left) and an amorphous structure 204 (right). Conventional springs may consist of metal or metal alloys, and thus have an ordered crystalline microstructure 202 (as illustrated on the left). In some examples, the present springs may comprise BMG and have an amorphous microstructure 204 (as illustrated on the right). As used herein, “amorphous” refers to materials lacking a regular or crystalline atomic structure. The amorphous materials of the present disclosure may be free or essentially free of repeating unit cells (e.g., cubic, tetragonal, orthorhombic, face-centered cubic, body-centered cubic, hexagonal, etc.). Alternatively, the amorphous materials of the present disclosure may have a relatively low degree of crystallinity.

BMGs are engineering alloys in which the structure is typically not crystalline. These alloys are disordered with the atoms occupying generally random positions. Again, the schematic in FIG. 2 shows this (reference numeral 204 on the right) compared to an ordered crystalline structure 202 (left). Amorphous structure 204 (left) can mean that the BMG does not have crystalline defects, such as dislocations. This is different from conventional alloys, where dislocations are present and can have a role in determining mechanical behavior of the conventional alloy.

A consequence of a BMG being an amorphous structure is that the BMG is stronger (e.g., 3-4 times or more) than their crystalline counterparts. Another consequence is that BMG offers large elastic deflections, which facilitates the spring to have a long stroke length. Additionally, the combination of high yield strength and large elastic deflection gives BMGs a high (e.g., exceptionally high) modulus of resilience, which enhances the ability of the spring to store elastic strain energy and release the strain energy when relaxed. Moreover, the absence of defects and grain boundaries typically leads to a strong corrosion resistance. Further, by modifying or tuning the chemical composition of the BMG, the BMG hydrogen resistance (and resistance to other compounds) can be tailored.

FIG. 3 is an Ashby plot showing Young's Modulus of various materials as a function of strength. It is a plot of Young's Modulus in gigapascal (GPa) versus strength in megapascal (MPa). As shown, BMGs (top right) may be characterized by both high strength and high elasticity. These properties may contribute to their superior macroscopic performance features. As illustrated, yield strength of a BMG may exceed the yield strength of conventional alloys by a factor of two.

Young's modulus, E =σ/ε, quantifies the relationship between tensile or compressive stress σ (force per unit area) and axial strain ε (proportional deformation) in the linear clastic region of a material. The dotted lines in the plot show the boundary values of the modulus of resilience that quantifies the amount of clastic energy [given in megajoules per cubic meter (MJ/m³)] that a spring can absorb before failure. As indicated, energy absorbed by BMG springs may, in some examples, potentially be up to two orders of magnitude higher than the energy absorbed by conventional alloys.

Young's modulus (also referred to as the modulus of elasticity) is a mechanical property of solid materials indicative of tensile or compressive stiffness when force is applied lengthwise. Young's modulus is the modulus of elasticity for tension or axial compression and is a measure of the ability of a material to withstand changes in length when under lengthwise tension or compression. Young's modulus is defined as the ratio of the stress (force per unit area) applied to the object and the resulting axial strain (displacement or deformation) in the linear clastic region of the material. Young's modulus is equal to the longitudinal stress divided by the strain and quantifies the relationship between tensile or compressive (force per unit area) and axial strain (proportional deformation) in the linear elastic region of a material.

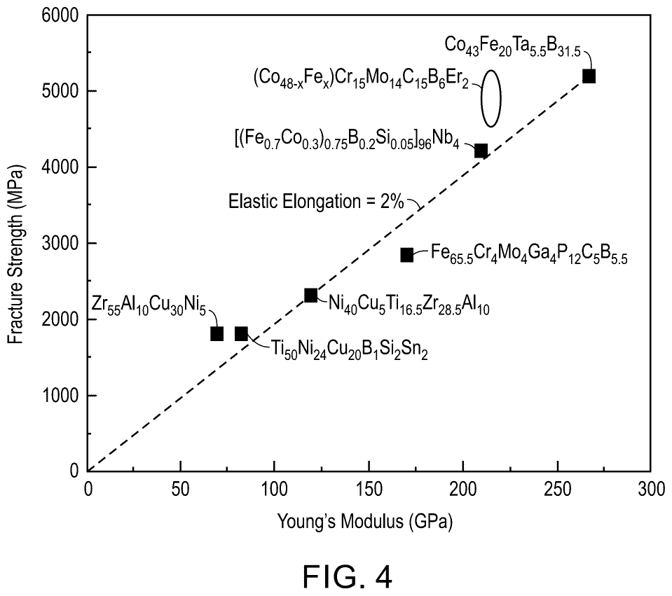

FIG. 4 is a plot of fracture strength (MPa) versus Young's modulus (GPa). The plot shows fracture strength of various materials as a function of Young's modulus. Fracture strength refers to the maximum amount of stress a material may withstand before failure. The notation “X” in the subscript of one species represented in FIG. 4 may be, for example, any integer number between 1 and 20. The various materials shown in FIG. 4 show a linear relationship between clastic modulus and fracture strength. The plot (FIG. 4) indicates how the composition of the BMG can be tailored to achieve different levels of yield strength and elastic modulus. A BMG comprising Co—Fe—Ta—B may have exceptionally high elastic modulus and strength, exceeding 260 GPa and 5000 MPa, respectively. This BMG can maintain a fully amorphous structure up to a diameter of 2 millimeters (mm). If a spring having a larger diameter (e.g., approximately 15 mm) is desired, the BMG comprising (Co—Fe)—Cr—Mo—C—B—Er is a good alternative, which has a comparable strength, while still maintaining a high clastic modulus (e.g., approximately 217 GPa).

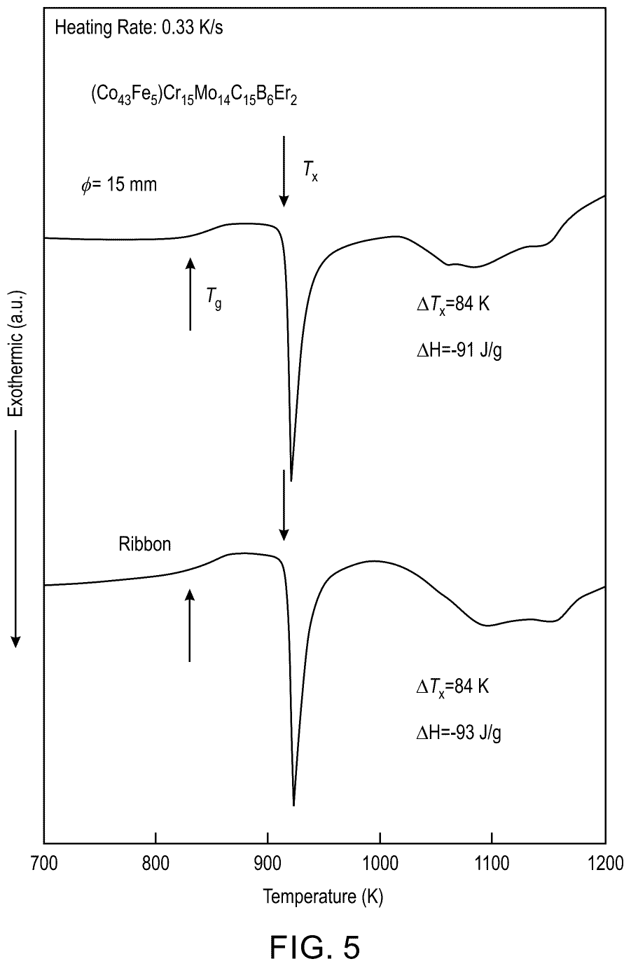

BMGs can work at high service temperatures, until their structure starts transforming from amorphous to an ordered structure. The temperature at which the amorphous-to-nanocrystalline transformation starts may be called the glass transition temperature. As long as the service temperature is below this temperature, BMGs can be reasonably utilized. Glass transition temperature of Co-based BMGs typically exceeds 450° C. With alloying additions, the thermal resistance of the BMG can be further increased. For example, the glass transition temperature of (Co—Fe)—Cr—Mo—C—B—Er based BMG is 570° C. (see FIG. 5), which is as much as 250° C. higher than the working temperature of Elgiloy.

FIG. 5 is a plot showing the glass transition temperature (T_{g}) of various compounds including two Co-based BMGs, one being a (Co—Fe)—Cr—Mo—C—B—Er based BMG and the other being a Co—Fe—Ta—B based BMG in accordance with some examples of the present disclosure. The plot is arbitrary units (a.u.) over temperature (Kelvin). The noted change in enthalpy is given in joules per gram (J/g). The BMG of FIG. 5 was heated at a heating rate of 0.33 Kelvin per second (K/s) and had a thickness [ϕ] of 15 mm. As illustrated, the (Co₄₃Fe₅) Cr₁₅Mo₁₄C₁₅B₆Er₂ based BMG has a glass transition temperature of approximately 925 K. The subscripts are weight percent of the BMG alloy. Other BMGs in accordance with the present disclosure may have glass transition temperatures from about 700 K to about 1200 K, or any ranges therebetween. BMGs may work at high service temperatures until their structure starts to transform from amorphous to an ordered structure. The temperature at which the amorphous-to-nanocrystalline transformation starts is called the glass transition temperature. As long as the service temperature is below this temperature, BMGs generally can be reasonably or safely used. Glass transition temperature of Co-based BMGs usually exceeds 450° C. With alloying additions, the thermal resistance of the BMG can be further increased. For example, as mentioned, the glass transition temperature of (Co—Fe)—Cr—Mo—C—B—Er based BMG is at least 570° C., which is as much as 250° C. higher than the working temperature of Elgiloy. Between the glass transition and crystallization temperatures, BMGs can flow like a viscous fluid. This is called super plasticity, which is a feature that uniquely differentiates the BMGs from conventional crystalline alloys. During superplastic flow, the BMGs man have high-temperature elongation in excess of 1000% without breakage.

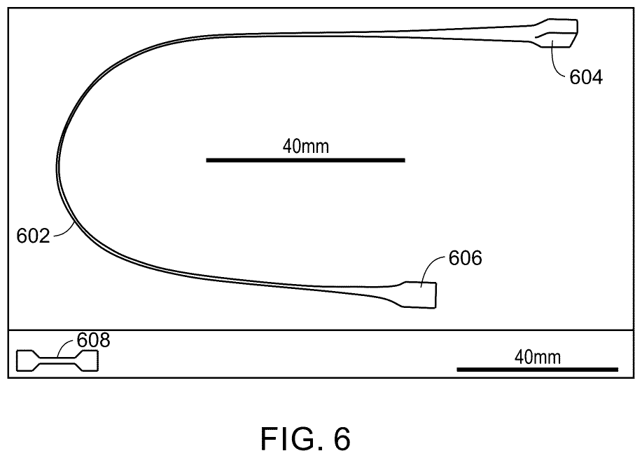

FIG. 6 is a top-down close-up view of an Mg-based BMG exhibiting super plasticity in accordance with some examples of the present disclosure. As illustrated, super plasticity of a Mg-based BMG material is evidenced by the long and unbroken strand 602 between two pulled-apart regions 604, 606 of the BMG. The BMG as formed before being pulled is indicated by the reference numeral 608. The dimension line given is 40 mm.

Other BMGs in accordance with the present disclosure may also exhibit super plasticity. In some implementations, superplastic behavior makes the BMGs highly formable, similar to thermoplastics, enabling the processing of complex BMG parts. As a result of these superior mechanical properties and excellent processability, springs made of BMG may, in some examples, outperform springs made of conventional materials, e.g., MP35N and Elgiloy.

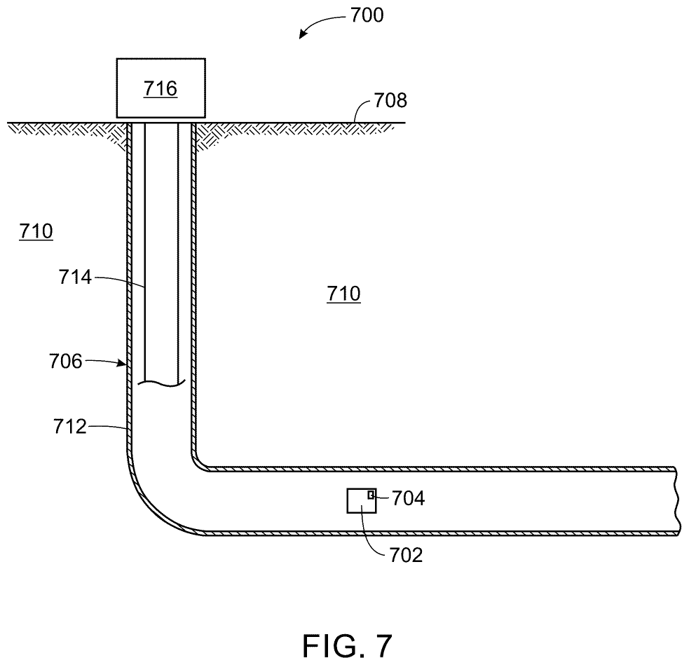

FIG. 7 is a well site 700 employing a downhole tool 702 having a spring 704. The spring 704 comprises BMG and therefore may be labeled as a BMG spring. The downhole tool 702 is depicted as the simplified representation of a square for clarity. In the illustrated embodiment, the downhole tool 702 is deployed in a wellbore 706. The downhole tool 702 as installed in the wellbore 706 may be set permanently or set as retrievable. The downhole tool 702 may be, for example, mechanically set or hydraulically set. As mentioned, the downhole tool 702 may be, for instance, a mechanical packer, annular packer (e.g., retrievable packer), cavern packer, casing patch, tubing-retrievable safety valve, casing repair tool, gas lift mandrel, tubing plug, casing pressure testing tool, downhole shut-off tool, centralizer, casing scraper, liner hanger, hydraulic tool, setting tool, safety valve, bridge plug, frac plug, ICD, cement retainer, tubing anchor, fishing tool, swab cup, jet perforation tool, circulation tool, gas lift valve, safety joint, and so forth. The spring 704 may be, for example, a compression spring, a coil spring, a torsion spring, an extension spring, a leaf spring, a constant force spring, a garter spring, a flapper spring, or a push spring, or any combinations thereof.

The wellbore 706 is formed through the Earth surface 708 into a subterranean formation 710 in the Earth crust. In forming (drilling and completing) the wellbore 706, downhole tools having a BMG spring may be employed. In the illustrated implementation, the wellbore 706 has the casing 712 and is therefore a cased wellbore. Cement (not shown) may be disposed between the casing 712 and the formation 710 face. The formation 710 face can be considered a wall of the wellbore 706. The casing 712 may be secured within the wellbore 706 by the cement. The casing 712 may be, for example, metal, plastic, composites, and the like, and may be expanded or unexpanded as part of an installation procedure.

Perforations may be formed through the casing 712 (and cement) for entry of fluid (e.g., hydrocarbon, water, etc.) from the subterranean formation 710 into the wellbore 706 to be produced (routed) as produced fluid through the production tubing 714 to the surface 708. Surface equipment 716 situated at or near the wellbore 706 may include a wellhead for receipt of the produced fluid. In other implementations, the wellbore 706 can be utilized for injection of fluid from the surface 708 through the wellbore 706 and the perforations in the casing 712 (and cement) into the subterranean formation 710.

The surface equipment 716 can include a hoisting apparatus (e.g., for raising and lowering pipe strings) and a derrick. The surface equipment 716 and equipment deployed in the wellbore 706 can include a wireline, slickline, coiled tubing, tubing string, pipe, drill pipe, drill string, and the like, that facilitates mechanical conveyance for deploying downhole tools (e.g., downhole tool 702 and other tools). The deployment of the downhole tool 702 may include lowering the downhole tool 702 into the wellbore 706 from the surface 708 and setting (e.g., via mechanical slips or other mechanisms) the downhole tool 702 in the wellbore 706. In some implementations, the equipment (e.g., wireline) may provide electrical connectivity, for example, to actuate the downhole tool 702. For example, a packer or plug as a downhole tool may be actuated to seal off a portion of the wellbore 706. Other examples and reasons for actuation are applicable.

The production tubing 714 may be a tubing string utilized in the production of hydrocarbons. The downhole tool 702 may be disposed on or near production tubing 714 in certain implementations. For examples of the downhole tool 702 as a packer or plug (e.g., frac plug, bridge plug, etc.) having the BMG spring 704, the downhole tool 702 may be set to isolate a lower part of the wellbore 706.

Applicable wellbores for the downhole tool 702 and its BMG spring 704 include vertical wellbores, horizontal wellbores, deviated wellbores, multilateral wells, and the like. It should be understood by those skilled in the art that the use of directional terms such as above, below, upper, lower, upward, downward, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well. Also, even though FIG. 7 depicts an onshore operation, it should be understood by those skilled in the art that the present techniques are applicable for offshore operations. In addition, while FIG. 7 depicts use of the downhole tool 702 in a cased portion of wellbore 706, it should be understood that a downhole tool 702 may also be used in uncased portions (e.g., openhole portions) of the wellbore 706.

An embodiment is a method of positioning a downhole tool (e.g., 702) in a wellbore (e.g., 706), wherein the downhole tool has a spring (e.g., 704) comprising BMG. The positioning (deployment) of the downhole tool may involve lowering the downhole tool into the wellbore (e.g., 706) from the surface (e.g., 708). In implementations, the method includes exerting force on a component of the downhole tool with the spring. The BMG can be an amorphous structure without nanocrystalline phases. In implementations, the BMG comprises at least 40 at % of cobalt (Co), and may further comprise Fc, Cr, Mo, Er, Ta, Nb, Ni, or Cu, or any combinations thereof. In these implementations, the BMG may comprise at least two elements selected from Fe, Cr, Mo, Er, Ta, Nb, Ni, or Cu. In other words, the BMG may comprise in addition to the Co a first element and a second clement each being Fe, Cr, Mo, Er, Ta, Nb, Ni, or Cu, wherein the first clement is different than the second clement. The BMG may further include metalloids or non-metallic components, such as boron (B), carbon (C), phosphorous (P), or silicon (Si), or any combinations thereof.

In examples, the BMG is an alloy of Co—Fe—Ta—B with Co at least 40 at % of the BMG and in which the alloy may optionally further include additional metals, metalloids, and/or non-metallic components. In other examples, the BMG is an alloy of (Co—Fc)—Cr—Mo—C—B—Er with Co at least 40 at % of the BMG and in which the alloy may optionally further include additional metals, metalloids, and/or non-metallic components. A particular non-limiting example is (Co₄₃Fe₅) Cr₁₅Mo₁₄C₁₅B₆Er₂ having a glass transition temperature of approximately 925 K, was discussed with respect to FIG. 5. The subscripts are weight percent of the BMG alloy.

Non-metals or metalloids, such as B, C, etc. as included are generally part of the BMG metal alloy (e.g., instead of merely present such as alongside the metal alloy). Non-metals or metalloids may be added while melting the alloy, as with other elements, to give the desired or specified microstructure after solidification.

As mentioned, the downhole tool (e.g., 702) may be a packer, a bridge plug, a frac plug, an ICD, a cement retainer, a casing patch, a safety valve (e.g., tubing-retrievable safety valve), a casing repair tool, a gas-lift mandrel, a gas-lift valve, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, or a safety joint, or any combinations thereof. A downhole shut-in tool facilitates operators to shut in the wellbore downhole rather than at the surface. A setting tool is a downhole tool utilized to run and set downhole plugs or similar equipment. A centralizer is a mechanical device that keeps well casing from touching the sides of the wellbore. A casing scraper is a wellbore clean-up tool with a blade-like attachment used to remove filter cake, scale, and debris and other obstructions from the internal surface of casing. A safety joint (e.g., release joint) may be a disconnect tool in the drill string utilized to mechanically separate the drill string in a controlled way. A circulation tool may facilitate or maintain circulation of drilling fluid during the drill pipe connection process. A circulation tool or circulating tool may have other implementations. A gas-lift mandrel may be tubing-retrievable and installed as a component of the tubing string, and provides for attachment of gas-lift devices. A gas-lift mandrel can be a section of pipe used in the tubing into which a gas lift valve can be inserted. A gas-lift mandrel may be gas-lift system component that is assembled with the production tubing string to provide for installing and retrieving gas-lift valves. A gas-lift valve may be utilized in a gas-lift system to control the flow of lift gas into the production tubing. The gas-lift valve is typically located in the gas-lift mandrel. A fishing tool may be a mechanical device utilized to recover equipment lost downhole. Fishing (e.g., in drilling operations) may mean the recycle of equipment or material left (or lost) downhole. In operation, a fishing tool may be, for example, screwed into the end of a fishing string (similar to drill pipe) and lowered into the wellbore. A packer may be a production packer, test packer, isolation packer, mechanical packer, hydraulic packer, annular packer, retrievable packer, permanently set packer, and so forth.

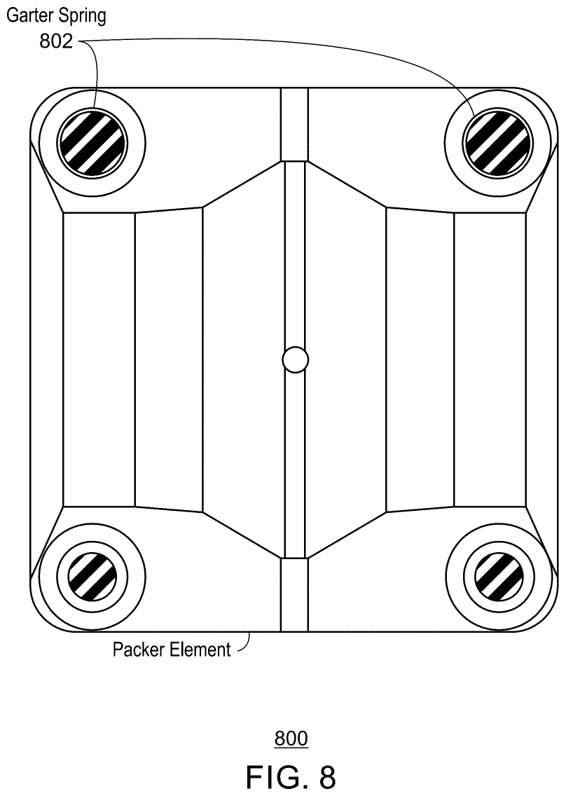

FIG. 8 is a packer element 800 for a downhole tool (e.g., 702 of FIG. 7). The packer element has a garter spring 802. In the illustrated example, the garter spring 800 includes BMG.

As discussed, BMGs may be incorporated into various springs. One example of such a spring is a garter spring which may be disposed within one or more regions of a packer element as illustrated. Further, springs that comprise BMGs may also include springs employed in any suitable downhole component (e.g., annular elements 104, 106 of FIG. 1).

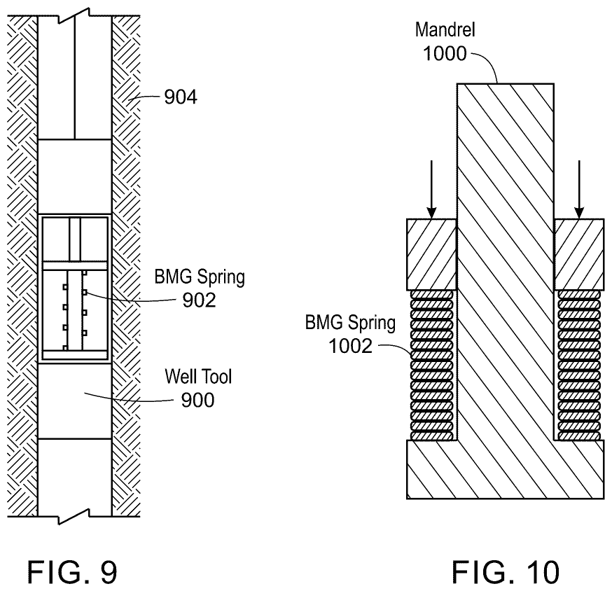

FIG. 9 is a cross sectional view of a downhole tool 900 (well tool) having a spring 902 that includes BMG in accordance with some examples of the present disclosure. The downhole tool 900 is disposed in a wellbore in a subterranean formation 904.

As illustrated, a spring comprising a BMG may be disposed about a central element of a downhole tool (well tool). Alternatively, the spring may be disposed around any element of a downhole tool, or simply be disposed within or without any inner or outer region of a well tool or wellbore component.

FIG. 10 is a cross sectional view of a portion of a downhole tool having a sliding mandrel 1000 and a spring 1002. The spring 1002 includes BMG in accordance with some examples of the present disclosure. In operation, the spring 1002 comprising a BMG may be used with the slidable mandrel 1000 to exert a downward (or upward) pressure on the downhole tool body attached to the mandrel 1000. While a specific apparatus including a mandrel is illustrated, it should be understood that a BMG spring may be used in other configurations for downhole applications.

FIG. 11 is a torsion spring 1100 for a downhole tool (downhole wellbore tool) including a tubing-retrievable safety valve. The torsion spring 1100 includes BMG. Thus, the spring 1100 is a BMG torsion spring. The downhole tool may employ a flapper spring hinge with the torsion spring 1100. The downhole tool may be or include a safety valve tool assembly.

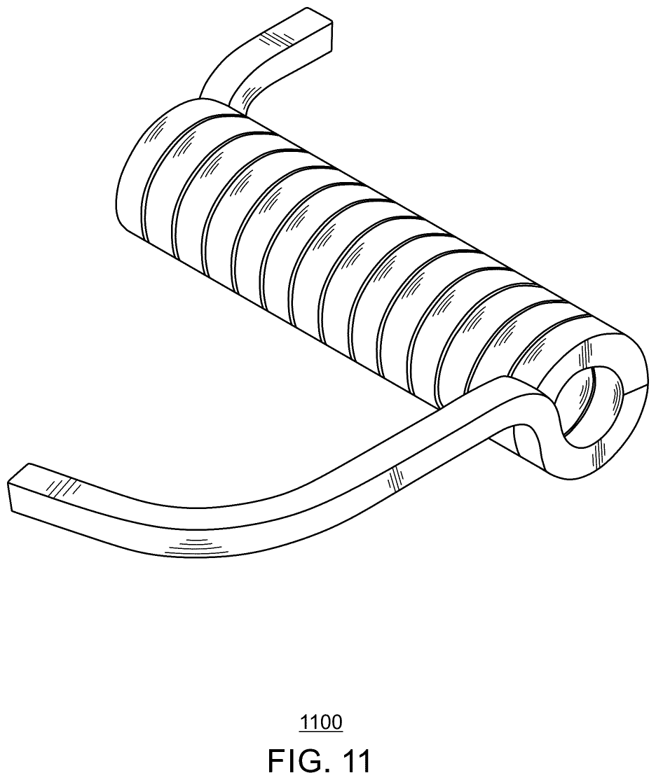

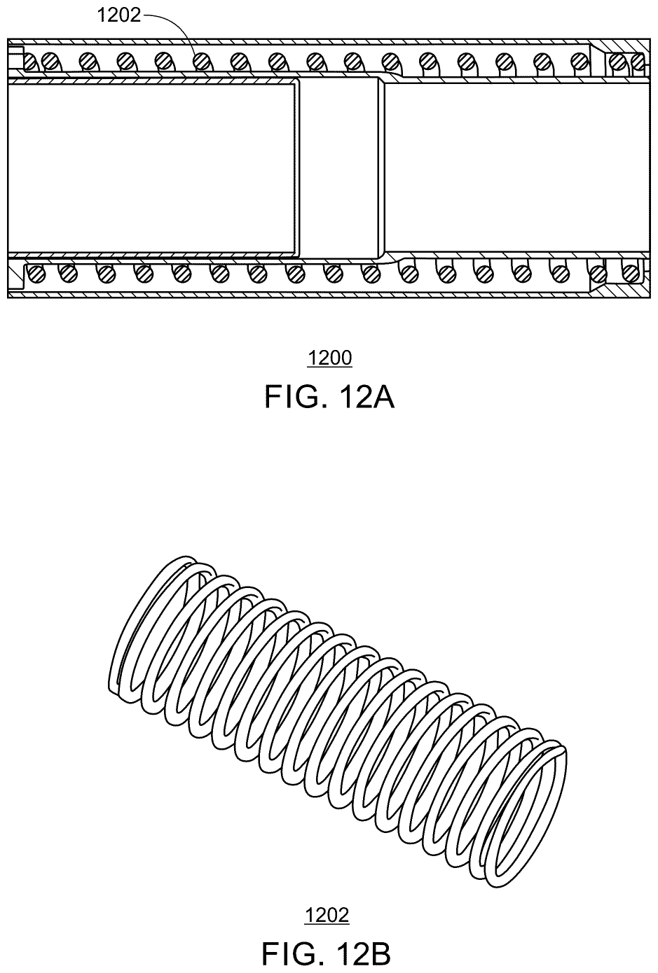

FIG. 12A is a portion 1200 of a downhole tool (downhole wellbore tool) having a torsion spring 1202 installed over a flow tube. The portion 1200 is depicted as cross-section. The downhole tool includes a tubing-retrievable safety valve and the torsion spring 1202. The torsion spring 1202 includes BMG and thus is a BMG spring.

FIG. 12B is the BMG torsion spring 1202 of the downhole tool portion 1200 depicted in FIG. 12A. The torsion spring 1202 may be labeled as a round torsion spring.

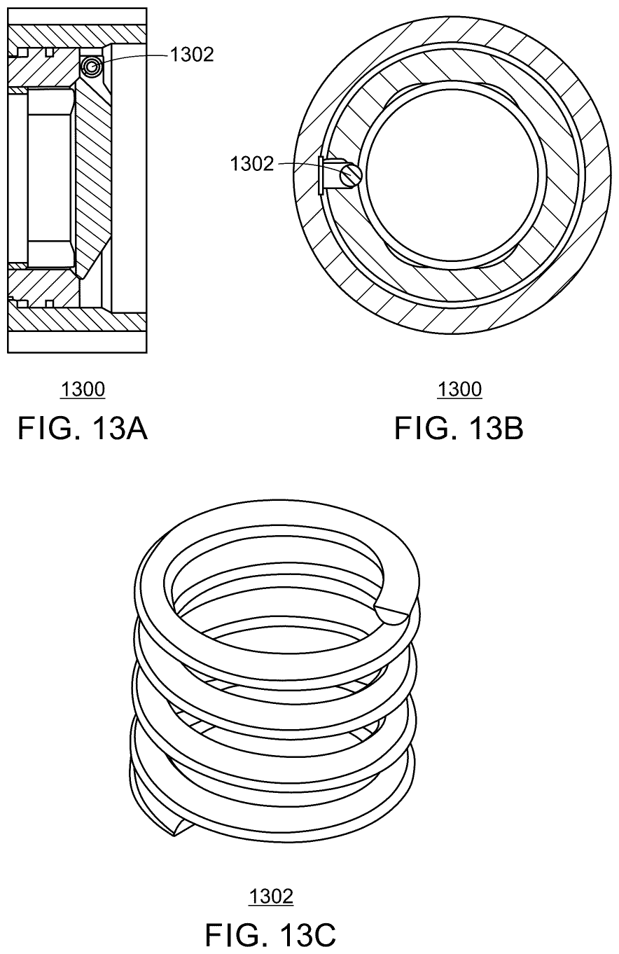

FIG. 13A is a side cross section of a portion 1300 of a downhole tool. The downhole tool includes a tubing-retrievable safety valve and a push spring 1302. The push spring 1302 includes BMG and thus is a BMG spring (BMG push spring).

FIG. 13B is an end cross section of the portion 1300 of the downhole tool of FIG. 13A. The BMG push spring 1302 is depicted. Again, the downhole tool includes the tubing-retrievable safety valve and the push spring 1302 (having BMG). FIG. 13C is the push spring 1302 of the downhole tool portion 1300 of FIG. 13A and FIG. 13B.

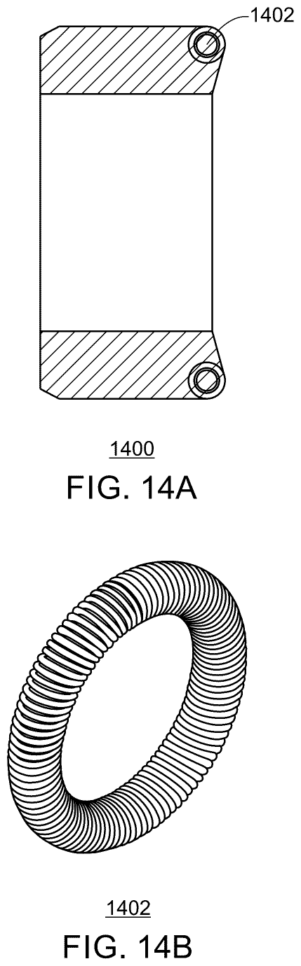

FIG. 14A is a side cross section of a portion 1400 of a downhole tool having a garter spring 1402. The garter spring 1402 includes BMG. The downhole tool is for a wellbore (borehole).

FIG. 14B is the garter spring 1402. The garter spring 1402 may be labeled as a BMG garter spring. The portion 1400 (FIG. 14A) of the downhole tool can be characterized as a portion of a packer element assembly having a BMG inner spring and a BMG outer spring.

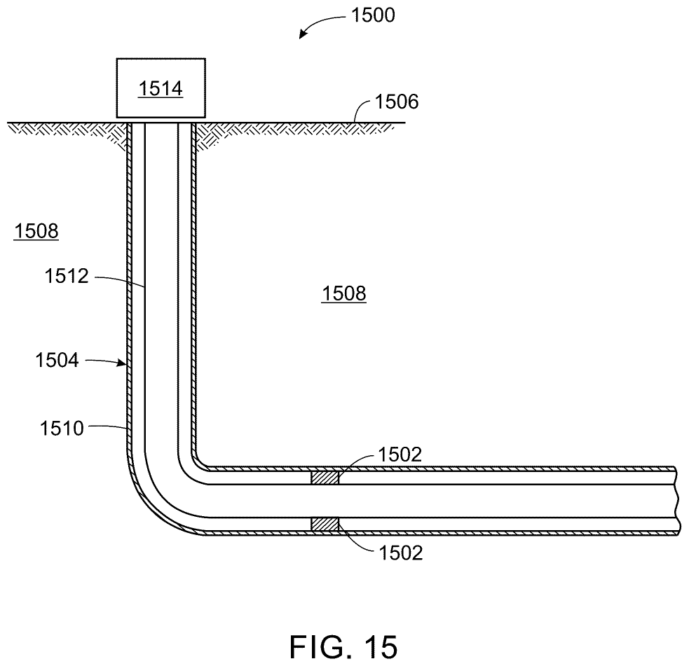

FIG. 15 is a well site 1500 that includes a downhole tool 1502 (having a BMG spring) in a wellbore 1504. The downhole tool 1502 may provide a seal in the wellbore 1504. Depending on the type of downhole tool 1502, the downhole tool 1502 may be permanently set or retrievable, mechanically set, hydraulically set, and/or combinations thereof. In examples, the downhole tool 1502 may be set downhole to seal off a portion of the wellbore 1504.

The wellbore 1504 is formed through the Earth surface 1506 into a subterranean formation 1508. In the illustrated implementation, the wellbore 1504 has a casing 1510 and is therefore a cased wellbore. In operation, fluid (e.g., hydrocarbon, water, etc.) may be produced from the subterranean formation 1508 through the wellbore 1504 as produced fluid through production tubing 1512 to the surface 1506. The surface equipment 1514 (e.g., analogous to surface equipment 716 of FIG. 7) may include a wellhead for receipt of the produced fluid. In examples, the production tubing 1512 may be a tubing string utilized in the production of hydrocarbons. The downhole tool 1502 may be disposed on or near the production tubing 1512. In implementations, when set, the downhole tool 1502 may isolate zones of the annulus between casing 1510 and the production tubing 1512 (e.g., a tubing string) by providing a seal (fluid seal) between the production tubing 1512 and the casing 1510. While FIG. 15 depicts use of the downhole tool 1502 in a cased portion of the wellbore 1504, a downhole tool 1502 may also be used in uncased portions (e.g., openhole portions) of a wellbore 1504.

The downhole tool 1502 may be a downhole tool with a packer element having or relying on the BMG spring. The packer element as a sealing element may fluidically isolate the lower part of the wellbore 1504 (downhole of the downhole tool 1502) from an upper part of the wellbore 1504 (uphole of the downhole tool 1502). When set, the downhole tool 1502 (e.g., packer, bridge plug, cement retainer, etc.) may isolate zones of the annulus between the casing 1510 and the production tubing 1512 (e.g., a tubing string) by providing a seal (fluid seal) via the packer element between the production tubing 1512 and the casing 1510. In examples, the downhole tool 1502 may be disposed on the production tubing 1512.

For examples of the downhole tool 1502 as a packer having the BMG spring, the packer may be a device that can be run into the wellbore 1504 with a smaller initial outside diameter that then expands externally to seal the wellbore 1504. Packers may employ flexible, elastomeric elements, mechanical elements, or other types of components or packer elements that expand. A production packer may isolate the annulus, e.g., between the production tubing 1512 and the casing 1510 (or wellbore 1504 wall) and anchor or secure the bottom of the production tubing string. A retrievable packer may be a type of packer that is run and retrieved on a running string or production string, unlike a permanent production packer that is set in the casing or liner before the production string is run. A typical packer assembly secures the packer against the casing 1510 or liner wall, such as by a slip arrangement of the packer, and creates (forms) a hydraulic seal via sealing elements (e.g., elastomeric component as an expandable elastomeric element, or another type of expandable element, etc.) of the packer to isolate the annulus. Packers are typically classified by application, setting method and possible retrievability.

For examples of the downhole tool 1502 as a bridge plug having the BMG spring, the bridge plug may be installed to permanently seal the wellbore 1504 or installed temporarily to perform work on or via the wellbore 1504. Bridge plugs are downhole tools that can be located in the wellbore 1504 and set to isolate the lower part of the wellbore 1504 (further downhole). The bridge plug is generally run in hole and set to isolate a lower zone of the wellbore 1504 from an upper zone of the wellbore 1504. Bridge plugs may be permanent or retrievable, facilitating the lower wellbore to be permanently sealed from production or temporarily isolated from a treatment conducted on an upper zone of the wellbore 1504. A bridge plug can include slips (e.g., mechanical slips), a mandrel, and scaling element (e.g., expandable, elastomer, rubber, mechanical, packer element, etc.). A bridge plug may be run (e.g., run on a wireline or pipes, and/or through a tubing string) and set (e.g., set in casing 1510 or tubing 1512) to isolate a lower zone of the wellbore 1504 while an upper section of the wellbore 1504 is tested, cemented, stimulated (e.g., hydraulically fracturing of the subterranean formation 1508), produced (e.g., hydrocarbon and/or water produced from the subterranean formation 1508 through the wellbore 1504), or injected (injection from surface 1506 through the wellbore 1504 into the subterranean formation 1508). The bridge plug may isolate the upper zone from the lower zone, preventing or reducing fluids of the lower zone (downhole of the bridge plug) from reaching an upper zone (uphole of the bridge plug) of the wellbore 1504. Again, such isolation may exist while the upper zone (section) is tested, cemented, stimulated, produced, or injected either permanently or temporarily within the wellbore 1504.

An embodiment is a downhole tool for a wellbore and in which the downhole tool has a spring (e.g., a compression spring, a coil spring, a torsion spring, an extension spring, a leaf spring, a constant force spring, a garter spring, a flapper spring, or a push spring, or any combinations thereof) having BMG. Another embodiment is a method involving positioning the downhole tool in the wellbore, and in which the method may include exerting force on a component of the downhole tool with the spring. In these two embodiments, the BMG may be an amorphous structure without nanocrystalline phases. The BMG may have a glass transition temperature of at least 450° C. In examples, the BMG has at least 40 at % of cobalt (Co) and may further include at least two elements selected from iron (Fc), chromium (Cr), molybdenum (Mo), erbium (Er), tantalum (Ta), niobium (Nb), nickel (Ni), or copper (Cu), and may further include boron (B), carbon (C), phosphorous (P), or silicon (Si), or any combinations thereof. In implementations, the BMG has at least 40 at % of Co and includes Fe and Ta, and may further include, for example, B. In implementations, the BMG has at least 40 at % of Co and includes Fe, Cr, Mo, and Er, and may further include, for example, C and B. The downhole tool may include, for example, a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

Yet another embodiment is a spring including BMG (e.g., having a glass transition temperature of at least 450° C.), wherein the spring is configured for a downhole tool (examples listed above) for a wellbore, wherein the BMG has at least at least 40 at % of cobalt (Co) and at least two elements selected from iron (Fe), chromium (Cr), molybdenum (Mo), erbium (Er), tantalum (Ta), niobium (Nb), nickel (Ni), or copper (Cu), and wherein the spring may be configured to exert a force on a component of the downhole tool. The BMG may further have boron (B), carbon (C), phosphorous (P), or silicon (Si), or any combinations thereof. The spring may be, for example, a compression spring, a coil spring, a torsion spring, an extension spring, a leaf spring, a constant force spring, a garter spring, a flapper spring, or a push spring, or any combinations thereof.

In implementations, a BMG spring in accordance with the present disclosure may have a yield strength that exceeds the yield strength of MP35N by a factor of four and of Elgiloy by a factor of two. In implementations, a BMG spring in accordance with the present disclosure may be chemically inert and may operate over a wider temperature range as compared to MP35N and Elgiloy. In implementations, the BMG springs of the present disclosure may exhibit improved peak force. For example, peak force may be 2-4 times greater than the peak force achievable with conventional springs. This may allow for improved load bearing capability. In implementations, the BMG springs of the present disclosure may exhibit increased cryogenic compatibility. In implementations, the BMG springs of the present disclosure may exhibit high-temperature elongation. This may contribute to a large clastic deflection.

In implementations, the BMG springs of the present disclosure may exhibit improved chemical resistance. Chemical resistance may include, for example, improved (increased) resistance to corrosion, such as corrosion by hydrogen, water, acid (e.g., inorganic acids, carbonic acid from high levels of CO₂ dissolved in water, etc.). Resistance to corrosion may be attributed in certain implementations to an absence of grain boundaries due to the amorphous structure of the BMG. In implementations, the BMG springs may exhibit strong corrosion resistance in NaCl, H₂SO₄, and/or HCl, without undergoing pitting in chloride containing solutions.

In implementations, the BMG springs of the present disclosure may exhibit improved energy absorption. For example, energy absorption may be at least 5-10 times greater compared to the current state-of-the-art springs made of Elgiloy or MP35N. Since BMG springs may, in some examples, clastically absorb large amounts of energy, plastic strain and hence fatigue may be reduced or eliminated. In contrast, plastic deformation of conventional springs is hard to avoid and often requires shot-peening of the conventional springs to safeguard against any potential fatigue occurring during service.

In implementations, the BMG springs of the present disclosure may exhibit high modulus of clastic resilience. This may allow the BMG springs to achieve the aforementioned high energy absorption capability. High clastic resilience may, in some examples, increase or maximize the deflection and high yield strength is important to increase or maximize the allowable stress. Thus, the amount of energy that the spring can absorb before failure may be increased. The BMG springs may have a high elastic modulus (e.g., at least 200 GPa), thereby enabling the spring to have a large spring constant.

In implementations, the BMG springs of the present disclosure may exhibit decreased susceptibility to fatigue. In implementations, the BMG springs of the present disclosure may exhibit improved (increased) working temperature. For example, the working temperature of BMG springs may be between 250° C. and 300° C. greater compared to Elgiloy or MP35N springs, or any ranges therebetween. When a low working temperature is desired, e.g., in CCUS applications, a BMG with an alternative or different composition may be used.

In implementations, the BMG springs of the present disclosure may exhibit improved strength (e.g., tensile strength). For example, the BMGs are much stronger (e.g., 3-4 times or more) than their crystalline counterparts. In examples, the BMG springs may have high elastic modulus (at least 200 GPa) and high strength (at least 5000 MPa) such that the spring has a large stroke length and an enhanced (increased) capability to store and release elastic strain energy.

In implementations, Co may be present in the BMG springs of the present disclosure in an amount, for example, greater than 40 at %. In some implementations, the BMG springs of the present disclosure may comprise non-metal or metalloid elements, e.g., B, C, P, or Si, or any combinations thereof. In some implementations, the BMG springs of the present disclosure may have a glass transition temperature of 450° C. or higher. This may allow for high glass formability, manifested by a critical casting diameter of at least 2 mm. In some examples, high glass formability may permit the BMG springs to maintain an amorphous structure up to a spring wire diameter of at least 2 mm, without forming any nanocrystalline phases. Transmission electron microscopy (TEM) may be employed to confirm the presence or absence of nanocrystals. The BMG springs may be characterized by superplastic flow which may impart thermoplastic processability to the BMG and permit production of BMG springs by techniques, for example, thermoplastic forming. The composition and amorphous structure of the BMG may be such that it has a superplastic elongation of at least 400%.

Accordingly, the present disclosure may provide BMG springs for use in downhole applications as well as methods of use and manufacture thereof.

In view of the foregoing, the present disclosure may provide for a BMG spring and for a downhole tool having the BMG spring. The methods, systems, and tools may include any of the various features disclosed herein, including one or more of the following statements.

Statement 1. A downhole tool for a wellbore, the downhole tool comprising a spring comprising BMG.

Statement 2. The downhole tool of Statement 1, wherein the BMG is an amorphous structure without nanocrystalline phases.

Statement 3. The downhole tool of Statement 1 or 2, wherein the BMG comprises at least 40at % of cobalt (Co).

Statement 4. The downhole tool of any preceding Statement, wherein the BMG comprises at least two elements selected from iron (Fe), chromium (Cr), molybdenum (Mo), erbium (Er), tantalum (Ta), niobium (Nb), nickel (Ni), or copper (Cu).

Statement 5. The downhole tool of any preceding Statement, wherein the BMG comprises boron (B), carbon (C), phosphorous (P), or silicon (Si), or any combinations thereof.

Statement 6. The downhole tool of any preceding Statement, wherein the BMG comprises: Fe and Ta; or Fe, Cr, Mo, and Er.

Statement 7. The downhole tool of any preceding Statement, wherein the BMG comprises a glass transition temperature of at least 450° C.

Statement 8. The downhole tool of any preceding Statement, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

Statement 9. The downhole tool of any preceding Statement, wherein the spring comprises a compression spring, a coil spring, a torsion spring, an extension spring, a leaf spring, a constant force spring, a garter spring, a flapper spring, or a push spring, or any combinations thereof.

Statement 10. A method comprising positioning a downhole tool in a wellbore, wherein the downhole tool comprises a spring comprising BMG.

Statement 11. The method of Statement 10, comprising exerting force on a component of the downhole tool with the spring.

Statement 12. The method of Statement 10 or 11, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

Statement 13. The method of Statement 10 to 12, wherein the spring comprises a compression spring, a coil spring, a torsion spring, an extension spring, a leaf spring, a constant force spring, a garter spring, a flapper spring, or a push spring, or any combinations thereof.

Statement 14. The method of Statement 10 to 13, wherein the BMG is an amorphous structure without nanocrystalline phases.

Statement 15. The method of Statement 10 to 14, wherein the BMG comprises at least 40 at % of cobalt (Co).

Statement 16. The method of Statement 10 to 15, wherein the BMG comprises iron (Fe), chromium (Cr), molybdenum (Mo), erbium (Er), tantalum (Ta), niobium (Nb), nickel (Ni), or copper (Cu), or any combinations thereof.

Statement 17. The method of Statement 10 to 16, wherein the BMG comprises boron (B), carbon (C), phosphorous (P), or silicon (Si), or any combinations thereof.

Statement 18. A spring comprising BMG, wherein the spring is configured for a downhole tool for a wellbore, wherein the BMG comprises at least at least 40 at % of cobalt (Co), and wherein the BMG comprises at least two elements selected from iron (Fe), chromium (Cr), molybdenum (Mo), erbium (Er), tantalum (Ta), niobium (Nb), nickel (Ni), or copper (Cu).

Statement 19. The spring of Statement 18, wherein the BMG comprises boron (B), carbon (C), phosphorous (P), or silicon (Si), or any combinations thereof.

Statement 20. The spring of Statement 18 or 19, wherein the BMG comprises a glass transition temperature of at least 450° C., and wherein the spring is configured to exert a force on a component of the downhole tool.

Statement 21. The spring of Statement 18 to 20, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

Statement 22. The spring of Statement 18 to 20, wherein the spring comprises a compression spring, a coil spring, a torsion spring, an extension spring, a leaf spring, a constant force spring, a garter spring, a flapper spring, or a push spring, or any combinations thereof.

To facilitate a better understanding of the present invention, the following examples of certain aspects of some examples are given. In no way should the following examples be read to limit, or define, the entire scope of the disclosure.

### EXAMPLES

Table 1 shows a comparison of various material properties of two Co—Fe based BMGs with MP35N and Elgiloy.

TABLE 1

| | Co—Fe—Ta—B | (Co—Fe)—Cr—Mo—C—B—Er | | |
|---|---|---|---|---|
| Material Property | based BMG | based BMG | MP35N | Elgiloy |
| Young's Modulus | 217 | 260 | 179 | 203 |
| of Elasticity | | | | |
| (GPa) | | | | |
| Tensile Strength | 5200 | 5200 | 1345 | 2413 |
| (GPa) | | | | |
| Elastic Resilience | 24 | 20 | 7.5 | 11.9 |
| (YS/E) | | | | |
| Modulus of | 124,608 | 100,000 | 9,441 | 19,704 |
| Resilience | | | | |
| (YS²/E) | | | | |
| Maximum | >550 | >550 | 260 | 316 |
| Working | | | | |
| Temperature (° C.) | | | | |

As shown in Table 1, both the Co—Fe—Ta—B based BMG and the (Co—Fe)—Cr—Mo—C—B—Er based BMG show superior physical properties than the MP35N and Elgiloy. Increased elastic modulus may have a positive effect on the spring constant of a spring. Increased yield strength may have a positive effect on its peak force. Increased elastic resilience may have a positive effect on its stroke length. Increased modulus of resilience may have a positive effect on its energy absorption. The chemistry and microstructure of the BMG may affect its maximum working temperature.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, as the present examples may be modified and practiced in different but equivalent manners apparent to those skilled in the art having the benefit of the teachings herein. Although individual examples are discussed, all combinations of each example are contemplated and covered by the disclosure. Furthermore, no limitations are intended to the details of construction or design shown herein, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of the present disclosure.

What is claimed is:

1. A downhole tool for a wellbore, the downhole tool comprising a spring comprising bulk metallic glass (BMG).

2. The downhole tool of claim 1, wherein the BMG is an amorphous structure without nanocrystalline phases.

3. The downhole tool of claim 1, wherein the BMG comprises at least 40 atomic percent (at %) of cobalt (Co).

4. The downhole tool of claim 3, wherein the BMG comprises at least two elements selected from iron (Fe), chromium (Cr), molybdenum (Mo), erbium (Er), tantalum (Ta), niobium (Nb), nickel (Ni), or copper (Cu).

5. The downhole tool of claim 3, wherein the BMG comprises boron (B), carbon (C), phosphorous (P), or silicon (Si), or any combinations thereof.

6. The downhole tool of claim 3, wherein the BMG comprises:
Fe and Ta; or
Fe, Cr, Mo, and Er.

7. The downhole tool of claim 1, wherein the BMG comprises a glass transition temperature of at least 450° C.

8. The downhole tool of claim 1, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

9. The downhole tool of claim 1, wherein the spring comprises a compression spring, a coil spring, a torsion spring, an extension spring, a leaf spring, a constant force spring, a garter spring, a flapper spring, or a push spring, or any combinations thereof.

10. A method comprising positioning a downhole tool in a wellbore, wherein the downhole tool comprises a spring comprising bulk metallic glass (BMG).

11. The method of claim 10, comprising exerting force on a component of the downhole tool with the spring.

12. The method of claim 10, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

13. The method of claim 10, wherein the spring comprises a compression spring, a coil spring, a torsion spring, an extension spring, a leaf spring, a constant force spring, a garter spring, a flapper spring, or a push spring, or any combinations thereof.

14. The method of claim 10, wherein the BMG is an amorphous structure without nanocrystalline phases.

15. The method of claim 10, wherein the BMG comprises at least 40 atomic percent (at %) of cobalt (Co).

16. The method of claim 15, wherein the BMG comprises iron (Fe), chromium (Cr), molybdenum (Mo), erbium (Er), tantalum (Ta), niobium (Nb), nickel (Ni), or copper (Cu), or any combinations thereof.

17. The method of claim 15, wherein the BMG comprises boron (B), carbon (C), phosphorous (P), or silicon (Si), or any combinations thereof.

18. A spring comprising bulk metallic glass (BMG), wherein the spring is configured for a downhole tool for a wellbore, wherein the BMG comprises at least at least 40 atomic percent (at %) of cobalt (Co), and wherein the BMG comprises at least two elements selected from iron (Fe), chromium (Cr), molybdenum (Mo), erbium (Er), tantalum (Ta), niobium (Nb), nickel (Ni), or copper (Cu).

19. The spring of claim 18, wherein the BMG comprises boron (B), carbon (C), phosphorous (P), or silicon (Si), or any combinations thereof.

20. The spring of claim 18, wherein the BMG comprises a glass transition temperature of at least 450° C., and wherein the spring is configured to exert a force on a component of the downhole tool.

21. The spring of claim 18, wherein the downhole tool comprises a packer, a bridge plug, a cement retainer, a casing patch, a safety valve, a casing repair tool, a gas lift mandrel, a tubing plug, a casing pressure testing tool, a downhole shut-off tool, a centralizer, a casing scraper, a liner hanger, a hydraulic tool, a setting tool, a tubing anchor, a fishing tool, a swab cup, a jet perforation tool, a circulation tool, a gas-lift valve, or a safety joint, or any combinations thereof.

22. The spring of claim 18, wherein the spring comprises a compression spring, a coil spring, a torsion spring, an extension spring, a leaf spring, a constant force spring, a garter spring, a flapper spring, or a push spring, or any combinations thereof.
